(19) United States
(12) Patent Application Publication
(10) Pub. No.: US 2016/0139251 A1
(43) Pub. Date: May 19, 2016

(54) OBJECT INFORMATION ACQUIRING APPARATUS AND CONTROL METHOD THEREOF, AND ACOUSTIC SIGNAL ACQUIRING APPARATUS AND CONTROL METHOD THEREOF

(71) Applicant: CANON KABUSHIKI KAISHA, Tokyo (JP)

(72) Inventors: Toru Imai, St. Louis, MO (US); Yasufumi Asao, Kyoto-shi (JP); Takao Nakajima, Kawasaki-shi (JP)

(21) Appl. No.: 14/891,716

(22) PCT Filed: Jun. 9, 2014
(86) PCT No.: PCT/JP2014/065822

§ 371 Date: Nov. 17, 2015

(30) Foreign Application Priority Data
Jun. 18, 2013 (JP) 2013-127528

(51) Int. Cl. G01S 7/52; G01S 7/56

(52) U.S. Cl. CPC G01S 7/52004; G01S 7/56

(57) ABSTRACT

Provided is an object information acquiring apparatus having: a receiver in which a plurality of receiving elements to receive acoustic signals based on an acoustic wave propagated from an object is disposed on a two-dimensional surface, the plurality of receiving elements being divided into a plurality of receiving element groups including at least one receiving element respectively; a corrector that corrects signals received by the receiver; and a processor that acquires characteristic information in the object using the signals corrected by the corrector, wherein the receiver receives the acoustic signals for each of the plurality of receiving element groups with a time difference, and acquires the received signals, and the corrector corrects a time-based deviation.

### TECHNICAL FIELD

The present invention relates to an object information acquiring apparatus and a control method thereof, and an acoustic signal acquiring apparatus and a control method thereof.

### BACKGROUND ART

Recently many imaging apparatuses that use X-rays, ultrasound and MRI (nuclear Magnetic Resource Imaging methods) are used in medical fields. On the other hand, research in optical imaging apparatuses that acquire information in an organism (object) by propagating light irradiated from a light source, such as laser, through the object and detecting the propagated light or the like, have also been vigorously ongoing in the medical fields. As one such optical imaging technique, photoacoustic tomography (PAT) has been proposed.

In PAT, a pulsed light generated in the light source is irradiated onto an object, and an acoustic wave, generated from biological tissue that absorbed the energy of light propagated and diffused inside the object (hereafter called “photoacoustic wave”) is detected at a plurality of locations so as to acquire two-dimensional sound pressure distribution. Then these signals are analyzed and information related to the optical characteristic values inside the object is visualized. Thereby the optical characteristic value distribution inside the object, particularly optical energy absorption density distribution, can be acquired.

Conventional examples of the photoacoustic wave detector are a transducer using piezoelectric phenomena, and a transducer using the change in capacitance. Further, a detector using resonance of light was recently developed. This detector detects a photoacoustic wave by detecting the quantity of reflected light of an optical interference film that changes along with the change of sound pressure of the photoacoustic wave, using two-dimensionally arrayed photo-sensors.

The demands for an acoustic signal acquiring apparatus for medical purposes are: low cost; quickly acquiring the time-based changes of two-dimensional sound pressure distribution; and acquiring data at a faster cycle. If the object is an organism, acquiring and imaging acoustic signals in a short time, particularly at a medical site, decreases burden on the testee. Moreover, acquiring data at a faster cycle allows detecting an acoustic wave having high frequency. This is important to image inside the object at high resolution.

In order to acquire two-dimensional sound pressure data in a short time, detection methods to acquire data using a plurality of detectors which are arrayed on a two-dimensional surface have been proposed. For example, it is reported that in a detector using the resonance of light, a change in the quantity of reflected light on the optical interference film is detected using a CCD camera as the two-dimensional array type sensor using photoelectric conversion elements, in order to acquire two-dimensional sound pressure distribution of the acoustic wave all at once (see Non-patent Document 1). Another method is devised to acquire data by arranging the transducers on a two-dimensional surface.

Data acquisition methods using a two-dimensionally arrayed sensor are roughly classified into two types. One type is acquiring data on the two-dimensional sensor surfaces collectively, and the other type is sequentially acquiring data on each part of the arrayed element groups. In the case of detectors using the resonance of light, the former type is a detector that uses a CCD sensor as the photo-sensor, which acquires data on all the elements collectively; and the latter type is a detector using a CMOS sensor, which sequentially acquires data on each part of the element groups with a time difference.

The former collective method is called a “global shutter method”, and the later time difference method is called a “rolling shutter method”. Generally a rolling shutter type CMOS sensor can flexibly control the image sensing elements, therefore it is easy to make the data acquisition cycles faster, where acquiring an acoustic wave at higher frequency is expected. Generally the rolling shutter type CMOS sensor has lower power consumption, and is easier to mass produce than the CCD sensor, and is therefore inexpensive.

The method of sequentially acquiring data for each element group can also be used for a two-dimensionally arrayed transducer, which uses piezoelectric elements, cMUTs or the like. By using this data acquisition method, cost reducton can be expected since the number of amplifiers, A/D converts or the like can be decreased.

However, in the case of the rolling shutter method that sequentially acquires data for each part of arrayed element groups, a signal to be received deviates depending on the element group, since the data acquisition time deviates depending on the element group. This problem is known as “rolling shutter distortion” in a rolling shutter type CMOS sensor, which is used in a video camera. This is a phenomenon in which a distorted image differing from the original two-dimensional image is acquired when camera shaking or the like occurs. Patent Literature 1 discloses a method for correcting the rolling shutter distortion based on information from the camera shaking detection sensor.

### CITATION LIST

### Patent Literature

PTL 1: Japanese Patent Application Laid-open No. 2004-266322

### Non-Patent Literature

NPL 1: M. Lamont, P. Beard, “2D imaging of ultrasound fields using CCD array to map output of Fabry-Perot polymer film sensor”, Electronics Letters, 42, 3, (2006)

### SUMMARY OF INVENTION

### Technical Problem

The acoustic signal acquiring apparatus disclosed in NPL 1 uses a CCD sensor, therefore, compared with a CMOS sensor, it is difficult to make the data acquisition cycle faster to acquire a high frequency acoustic wave, and it is also difficult to receive acoustic signals over a wide band.

In the case of the solution of the rolling shutter distortion disclosed in PTL 1, it is possible to solve the spatial distortion of an image due to camera shaking or the like, but a problem that occurs in the case of using a CMOS sensor as the acoustic wave detection sensor cannot be solved. In other words, when an acoustic wave is detected, it is necessary to correct the time-based deviation of the reflected light quantity waveform for each element group, but the method disclosed in PTL 1 does not support this correction.

With the foregoing in view, it is an object of the present invention to acquire good images in an acoustic signal acquiring apparatus that sequentially acquires signals for each element group.

### Solution to Problem

The present invention provides an object information acquiring apparatus, comprising:

a receiver in which a plurality of receiving elements to receive acoustic signals based on an acoustic wave propagated from an object is disposed on a two-dimensional surface, the plurality of receiving elements being divided into a plurality of receiving element groups including at least one receiving element respectively;

a corrector configured to correct signals received by the receiver; and

a processor configured to acquire characteristic information in the object using the signals corrected by the corrector, wherein

the receiver receives the acoustic signals for each of the plurality of receiving element groups with a time difference, and acquires the received signals, and

the corrector corrects a time-based deviation among the received signals acquired for each receiving element group, based on the timing at which each receiving element group has received the acoustic signals.

The present invention also provides an acoustic signal acquiring apparatus, comprising:

a receiver in which a plurality of receiving elements to receive acoustic signals is disposed on a two-dimensional surface, the plurality of receiving elements being divided into a plurality of receiving element groups including at least one receiving element respectively;

a corrector configured to correct signals received by the receiver; and

a processor configured to analyze the signals corrected by the corrector, wherein

the receiver receives the acoustic signals for each of the plurality of receiving element groups with a time difference, and acquires the received signals, and

the corrector corrects a time-based deviation among the received signals acquired for each receiving element group, based on the timing at which each receiving element group has received the acoustic signals.

The present invention also provides a control method of an object information acquiring apparatus, which has: a receiver in which a plurality of receiving elements are disposed on a two-dimensional surface, the plurality of receiving elements being divided into a plurality of receiving element groups including at least one receiving element respectively; a corrector; and a processor,

the control method comprising:

a step of the receiver receiving acoustic signals based on an acoustic wave propagated from an object for each of the plurality of receiving element groups with a time difference, and acquiring the received signals;

a step of the corrector correcting a time-based deviation among the received signals acquired for each receiving element group, based on the timing at which each receiving element group has received the acoustic signals; and

a step of the processor acquiring characteristic information in the object using the signals corrected by the corrector.

The present invention also provides a control method of an acoustic signal acquiring apparatus, which has: a receiver in which a plurality of receiving elements are disposed on a two-dimensional surface, the plurality of receiving elements being divided into a plurality of receiving element groups including at least one receiving element respectively; a corrector; and a processor,

the control method comprising:

a step of the receiver receiving acoustic signals for each of the plurality of receiving element groups with a time difference, and acquiring the received signals;

a step of the corrector correcting a time-based deviation among the received signals acquired for each receiving element group, based on the timing at which each receiving element group has received the acoustic signals; and

a step of the processor analyzing the signals corrected by the corrector.

### Advantageous Effects of Invention

According to this invention, good images can be acquired in an acoustic signal acquiring apparatus that sequentially acquires signals for each element group.

Further features of the present invention will become apparent from the following description of exemplary embodiments with reference to the attached drawings.

### BRIEF DESCRIPTION OF DRAWINGS

FIG. 1 is a diagram depicting a configuration of an imaging apparatus of Embodiment 1;

FIG. 2 is a diagram depicting a configuration of a Fabry-Perot interferometer;

FIG. 3 is a diagram depicting a configuration of a Fabry-Perot probe;

FIG. 4 is a diagram depicting a configuration of a rolling shutter type photosensor;

FIG. 5 is a diagram depicting data acquisition timing of the photosensor and the time in memory;

FIG. 6 is a diagram depicting a received waveform stored in the memory of the photosensor;

FIG. 7A to FIG. 7D are graphs showing deviation of data acquisition time of each line of image sensing elements;

FIG. 8A and FIG. 8B are flow charts depicting signal deviation correction processes of the photosensor;

FIG. 9 is a diagram depicting a data acquisition timing of the photosensor;

FIG. 10A and FIG. 10B are diagrams depicting a method of correcting signal deviation of the photosensor;

FIG. 11 is a diagram depicting a data complementation method for a signal of the photosensor;

FIG. 12 is a diagram depicting a configuration of an imaging apparatus of Embodiment 2;

FIG. 13 is a diagram depicting a configuration of an imaging apparatus of Embodiment 3;

FIG. 14 is a diagram depicting a configuration of an array type transducer which outputs a received signal simultaneously;

FIG. 15 is a diagram depicting a configuration of an array type transducer which switches the switches; and

FIG. 16 is a diagram depicting a configuration of an imaging apparatus of Embodiment 4.

### DESCRIPTION OF EMBODIMENTS

Preferred embodiments of the present invention will now be described with reference to the drawings. Dimensions, materials, shapes of components and relative positions thereof in the following description should be changed appropriately according to the configuration of the apparatus to which the invention is applied and various conditions, and are not intended to limit the scope of the invention to the description hereinbelow.

An object information acquiring apparatus of the present invention includes an apparatus that utilizes a photoacoustic effect, which receives an acoustic wave generated in an object by light (electromagnetic wave) irradiated onto the object, and acquires characteristic information of the object as image data. In this case, the characteristic information to be acquired is an acoustic wave generation source distribution that is generated by the irradiated light, an initial sound pressure distribution in the object, an optical energy absorption density distribution or an absorption coefficient distribution derived from the initial sound pressure distribution, or a concentration distribution of a substance constituting a tissue. The concentration distribution of a substance is, for example, oxygen saturation distribution or oxyhemoglobin/deoxyhemoglobin concentration distribution.

The present invention can also be applied to an apparatus utilizing ultrasound echo technology, which transmits an elastic wave to an object, receives an echo wave reflected inside the object, and acquires the object information as image data. In this case, the characteristic information is information reflecting a difference in acoustic impedance of the tissues inside the object.

The present invention can be applied not only to the above apparatuses but also to any apparatus that acquires an acoustic wave using a later mentioned acoustic signal acquiring apparatus. In the following description, an imaging apparatus using photoacoustic tomography or an imaging apparatus that acquires characteristic information based on the reflected wave of the transmitted elastic wave will be described as typical examples of object information acquiring apparatuses using an acoustic signal acquiring apparatus.

The acoustic wave in this invention is typically an ultrasound wave including elastic waves that are called “sound waves”, “ultrasound waves” and “acoustic waves”. An acoustic wave generated as a result of the photoacoustic effect in the photoacoustic tomography is called a “photoacoustic wave” or a “light-induced ultrasound wave”.

An acoustic signal receiving element group disposed on a two-dimensional surface according to this invention is an array type photosensor in Embodiment 1 and 2, and an array type transducer in Embodiments 3 and 4.

### Embodiment 1

### Configuration

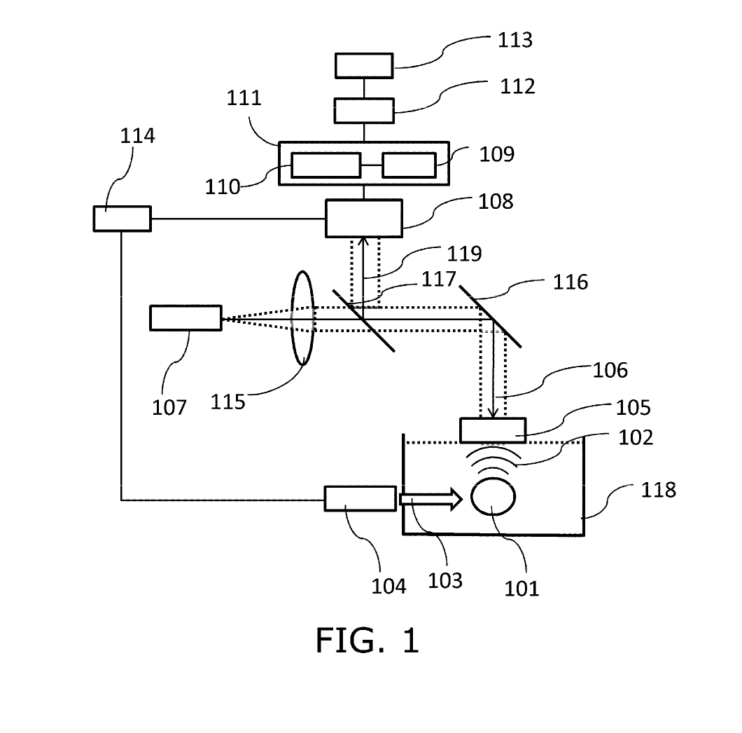

First an overview of a configuration of an imaging apparatus according to this embodiment will be described with reference to FIG. 1. The imaging apparatus of this embodiment includes an excitation light source 104 that emits excitation light 103. The excitation light 103 is irradiated onto an object 101. If the object 101 is an organism, light absorbers inside the object 101, such as a tumor and blood vessel, and light absorbers on the surface of the object 101, can be imaged. If these light absorbers absorb a part of the energy of the excitation light 103, a photoacoustic wave 102 is generated, which propagates in the object. The object 101 is placed in a water tank 118 which is filled with water.

The imaging apparatus generates a measurement light 106 by a light source for measurement light 107, and irradiates the measurement light 106 onto a Fabry-Perot probe 105, so as to detect a sound pressure of the photoacoustic wave 102. In concrete terms, the quantity of reflected light, generated by the measurement light 106 entering the Fabry-Perot probe 105 and then being reflected, is converted into an electric signal by an array type photosensor 108.

The excitation light generation timing of the excitation light source 104 and the data acquisition timing of the array type photosensor 108 are controlled by a control unit 114. In this embodiment, a rolling shutter type CMOS sensor is used as a typical example of the array type photosensor 108. Each of these blocks in FIG. 1 constitutes a photoacoustic signal acquiring apparatus.

The imaging apparatus is constituted by this acoustic signal acquiring apparatus, along with a signal correction unit 111 formed from a memory 109 and a corrector 110, a signal processing unit 112 and a display unit 113. The signal correction unit 111 appropriately corrects an electric signal acquired by the array type photosensor 108, and transfers the corrected electric signal to the signal processing unit 112. The signal processing unit 112 analyzes the corrected signal, and calculates optical characteristic value distribution information. The display unit 113 displays the calculated optical characteristic value distribution information. Here the memory 109 need not constitute only the signal correction unit 111, but may be common with a memory of the array type photosensor 108 or with a memory of the signal processing unit.

The measurement light 106 is enlarged by a lens 115, transits through a half mirror 117 and a mirror 116, and is reflected by the Fabry-Perot probe 105. Then the reflected light 119 transmits through the half mirror 117 and the mirror 116 again, and enters the array type photosensor 108, whereby intensity distribution of the reflected light on the Fabry-Perot probe 105 can be acquired.

The optical system to guide the measurement light can have any configuration only if the quantity of reflected light on the Fabry-Perot probe 105 can be measured. For example, a polarizing mirror and a wavelength plate may be used instead of the half mirror 117.

(Mechanism of Acoustic Wave Detection Using Resonance of Light)

A mechanism of an acoustic wave detection using the resonance of light according to this embodiment and a structure of a device to be used will be described next.

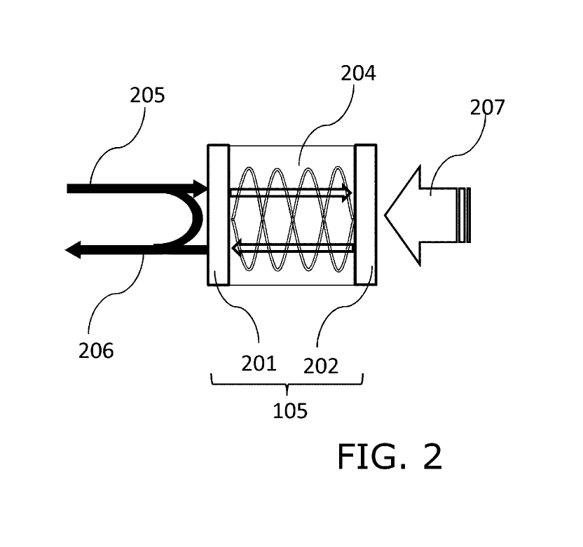

FIG. 2 is a schematic diagram of an acoustic detector using the resonance of light. The structure of resonating light between parallel reflection plates like this is called a “Fabry-Perot interferometer”. An acoustic wave detector utilizing the Fabry-Perot interferometer is called a “Fabry-Perot probe”.

The Fabry-Perot probe has a structure where a polymeric film 204 is sandwiched between a first mirror 201 and a second mirror 202. The thickness of the polymeric film 204 is denoted by d, which corresponds to a distance between the mirrors. Incident light 205 is irradiated onto the interferometer from the first mirror 201 side. In this case, quantity Ir of the reflected light 206 is given by the following Expression (1).

$$\begin{matrix}[ Math . 1 ] & \\ {I}_{r} = \frac{4 R {sin}^{2} \frac{ϕ}{2}}{{( 1 - R )}^{2} + 4 R {sin}^{2} \frac{ϕ}{2}} {I}_{i} & ( 1 )\end{matrix}$$

Here Ii denotes the quantity of incident light 205. R denotes a reflectance of the first mirror 201 and the second mirror 202, λ₀ denotes the wavelength of the incident light 205 and the reflected light 206, d denotes a distance between the mirrors, and n denotes a refractive index of the polymeric film 204. φ corresponds to a phase difference when the light reciprocates between the two mirrors, and is given by Expression (2).

$$\begin{matrix}[ Math . 2 ] & \\ ϕ = \frac{4 π}{{λ}_{0}} nd & ( 2 )\end{matrix}$$

When an acoustic wave 207 enters the Fabry-Perot probe, the distance between mirrors d changes. Thereby φ changes, and as a result the reflectance Ir/Ii changes. If the change of the reflected light quantity Ir is measured by a photosensor, such as a photodiode, the entered acoustic wave 207 can be detected. As the detected change of the reflected light quantity is greater, the intensity of the entered acoustic wave 207 is higher.

The Fabry-Perot probe measures the change of the reflected light quantity only for a position where the incident light 205 is received, hence the spot area of the incident light 205 is an area which has reception sensitivity.

In this embodiment, the array type photosensor 108 is used in order to quickly acquire a two-dimensional sound pressure distribution of the Fabry-Perot probe in an area having reception sensitivity.

Further, compared with a probe using PZT, the frequency band of an acoustic wave is wide in the Fabry-Perot probe. As a result, a highly precise image with high resolution can be acquired.

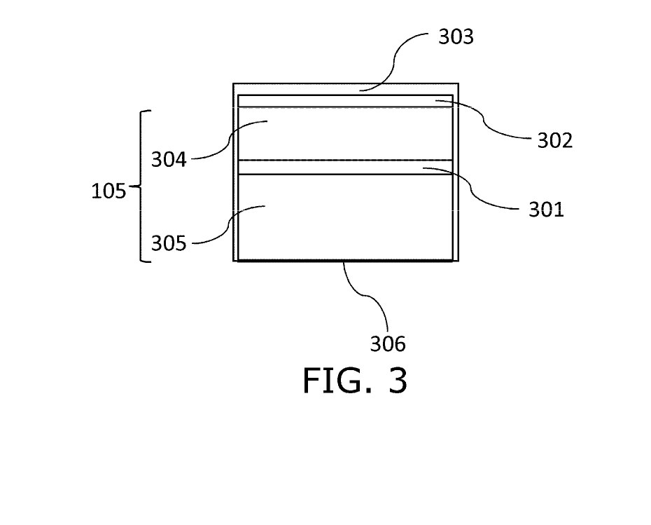

FIG. 3 is a diagram depicting a cross-sectional structure of the Fabry-Perot probe. For materials of a first mirror 301 and a second mirror 302, a dielectric multilayer film or a metal film can be used. A spacer film 304 exists between the mirrors. For the spacer film 304, a film which deforms when an elastic wave enters the Fabry-Perot probe is preferable. For example, such an organic polymeric film as parylene, SU8 or polyethylene is preferable, since deformation when an elastic wave is received is large. Other materials, including an inorganic film, may also be used only if the film has a deformation characteristic with respect to a sound wave.

The entire Fabry-Perot probe is protected by a protective film 303. For the protective film 303, a thin film of organic polymeric film, such as parylene, or an inorganic film, such as SiO₂, is used. Glass or acrylic can be used for a substrate 305 on which the second mirror 302 is deposited. The substrate 305 is preferably wedge-shaped, so as to decrease the influence of the interference of light inside the substrate 305. Moreover, it is preferable to perform AR coat processing 306 in order to prevent the reflection of light on the surface of the substrate 305.

(Problems of Rolling Shutter Type Photosensor)

Now the problems that are generated by using a rolling shutter type CMOS sensor as the array type photosensor 108 will be described. The following description is applicable to any rolling shutter type photosensor other than the CMOS sensor.

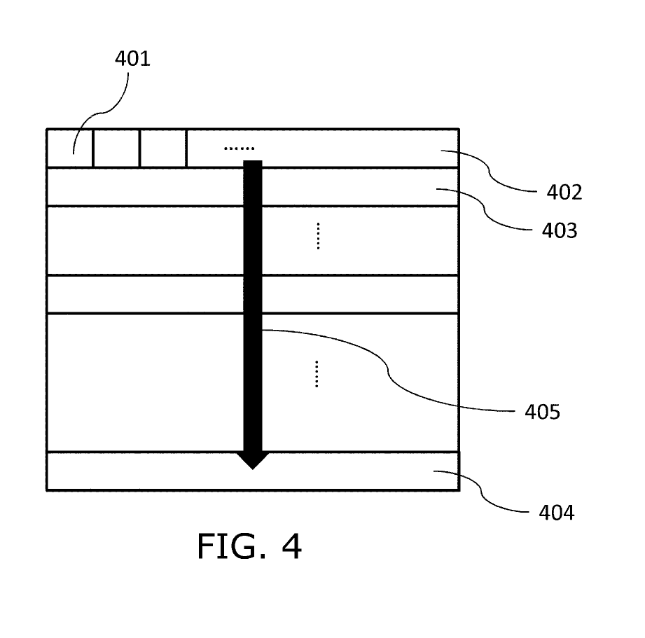

FIG. 4 is an overview diagram of a CMOS sensor. In the CMOS sensor, solid-state image sensing elements 401, such as photodiodes, are arrayed horizontally or vertically. Each specified group of image sensing elements sequentially acquires data with a time difference. In the case of FIG. 4, an image sensing element group is formed for each line in the horizontal direction. When photographing, the image sensing elements in the first horizontal line 402 acquire data first, then the image sensing elements in the second line 403 acquire data after a predetermined time difference. In this way, data is acquired up to the last line 404 in the imaging area in the sequence indicated by the arrow 405 in FIG. 4, whereby the imaging of one frame completes. This imaging method is called a “rolling shutter method”.

Information on the entire area of the CMOS sensor can be acquired by imaging one frame like this. If the image sensing elements in the first horizontal line 402 acquire data again after imaging one frame, imaging of the next frame is started. By each image sensing element group repeatedly imaging in each frame in a predetermined sequence like this, the number of times of data acquisition increases, whereby the S/N ratio improves, and long term observation of the object becomes possible. This is also called “frame imaging”. If the area of the detector is smaller than the imaging area, it is necessary to repeatedly image the frame while moving the detector over the object. In the case of this embodiment, the Fabry-Perot probe is moved, and in the case of an embodiment utilizing piezoelectric phenomena, which is described later, the array type transducer is moved. In FIG. 4, an individual image sensing element corresponds to the receiving element of the present invention, and each line constitutes the receiving element group. The acoustic signal of the present invention corresponds, in this case, to the intensity of light quantity of the reflected light, converted from the intensity of the photoacoustic wave.

In FIG. 4, an image sensing element group that acquires data simultaneously is constituted by a plurality of elements disposed on a same line. However the configuration of the image sensing element group is not limited to this. An individual image sensing element group is required that includes at least one image sensing element, normally a plurality of image sensing elements. Even when data is acquired for each line, the sequence of acquiring data may be an arbitrary sequence, not in one direction, as indicated by the arrow 405. When one frame is imaged, all the imaging sensing elements need not always acquire data. To implement high-speed imaging, data may be acquired by skipping lines. Therefore the processing for each line in the following description may be interpreted as a processing for each image sensing element group.

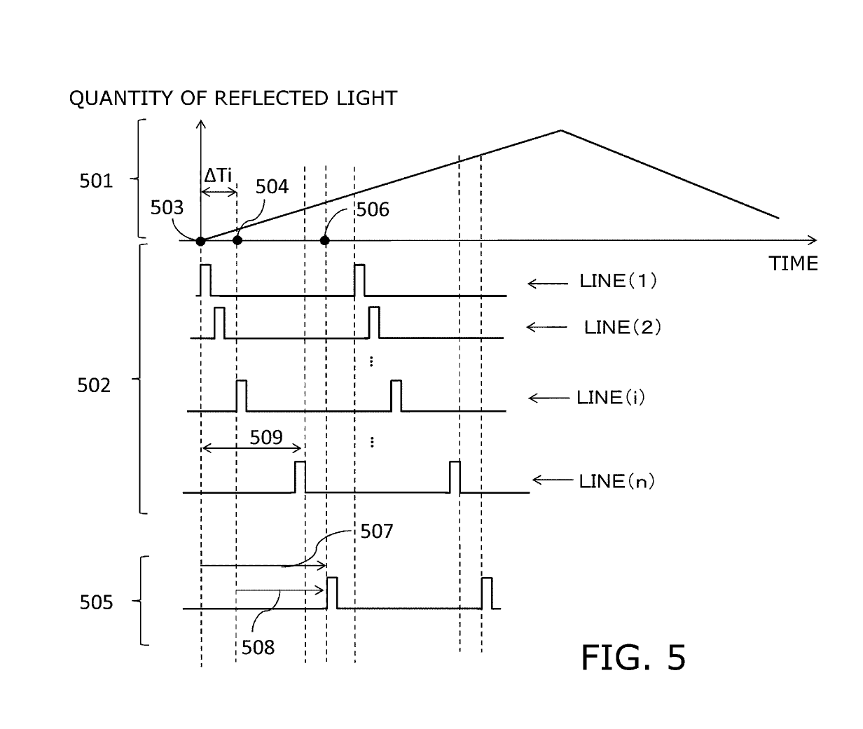

FIG. 5 shows a change waveform 501 of the quantity of reflected light that enters the CMOS sensor surface, a data acquisition timing 502 of each line, and an output timing 505 of the received signal. As described above, the quantity of reflected light that enters the CMOS sensor surface is a quantity that is converted into the intensity of the acoustic wave 102 on the sensor surface of the Fabry-Perot probe 105. Therefore the two-dimensional sound pressure distribution of the acoustic wave 102 can be acquired by detecting this quantity of reflected light.

The reference numeral 501 indicates a graph showing the time-based change of the quantity of reflected light that enters the CMOS sensor surface. The abscissa indicates the time, and the ordinate indicates the quantity of reflected light. Here it is assumed that the time-based change of the quantity of reflected light that enters is the same for all the lines of the image sensing elements in order to simplify description. However the following description can also be applied to the case when the time-based change of the quantity of reflected light is different for each line, hence description in this case is omitted.

The reference numeral 502 is a timing chart depicting the data acquisition timing (exposure timing) of each line and the data acquisition time. In FIG. 5, if the number of lines is n, LINE (1) is the data acquisition timing of the first line, LINE (i) is the data acquisition timing of the i-th line, and LINE (n) is the data acquisition timing of the n-th line (final line).

As shown in the timing chart 502, the data acquisition timing (exposure timing) of each line deviates by degrees. For example, the first line acquires data at time 503, and the i-th line acquires data at ΔTi later, that is at time 504. In this way, the image sensing elements of each line detect the quantity of reflected light at different timings within one frame. Therefore one frame imaging time (time required for completing data acquisition from the first to n-th lines) is a period indicated by the reference numeral 509 on LINE (n) in FIG. 5.

The reference numeral 505 indicates a timing chart showing a time when a signal received by each line is written to the memory 109. Data acquired by a CMOS sensor or the like is normally outputted to the outside as data of each frame, hence as shown here, receiving signals of all the lines are stored in the memory as data of the same timing after one frame is imaged. The arrow 507 or the arrow 508 indicates a difference of the data acquisition timing of the first line or that of the i-th line, and the actual timing at which the data is written to the memory 109 respectively.

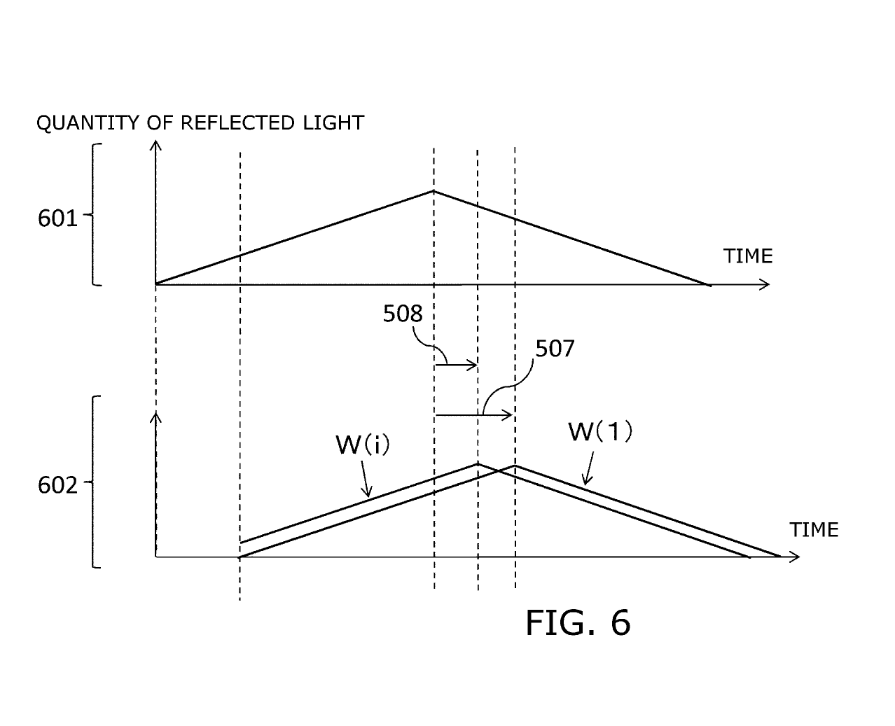

This matter will be further described with reference to FIG. 6. The reference numeral 602 indicates a graph showing the time-based change of the received signal of each line stored in the memory 109 when imaging in FIG. 5 is performed for a plurality of frames. In the graphs 601 and 602, the abscissa indicates time, and the ordinate indicates the quantity of reflected light.

In the graph 602, the received waveform of the first line is W(1), and the received waveform of the i-th line is W(i). Actually a received waveform to-be-stored is a set of plotted signals at each data acquisition time, but is represented by a continuous line for convenience. For example, in W(1), a quantity of reflected light, which the image sensing elements on the first line acquired in each frame, is stored in the memory at a timing that is delayed from the acquisition timing by the period indicated by the arrow 507, and is plotted on the coordinates regarding this quantity of reflected light as the quantity of reflected light acquired at the timing of the storing.

The reference numeral 601 indicates a graph showing the time-based change of the actual quantity of reflected light that enters the CMOS sensor surface, and corresponds to the reference numeral 501 in FIG. 5. As shown in the graph 602, the receiving signal of each line deviates according to the difference between the actual data acquisition timing and the storage timing at which the signal is stored in the memory 109. For example, W(1) delays from the waveform of the actual quantity of reflected light that enters the CMOS sensor surface by the amount of the time difference 507. W(i) delays from the waveform of the actual quantity of reflected light by the amount of the time difference 508.

In the description of the reference numeral 505 in FIG. 5, it is assumed that a signal received by each line is written to the memory 109 after one frame is imaged. However the above description is applicable even for a case when writing is performed for a plurality of times while imaging one frame.

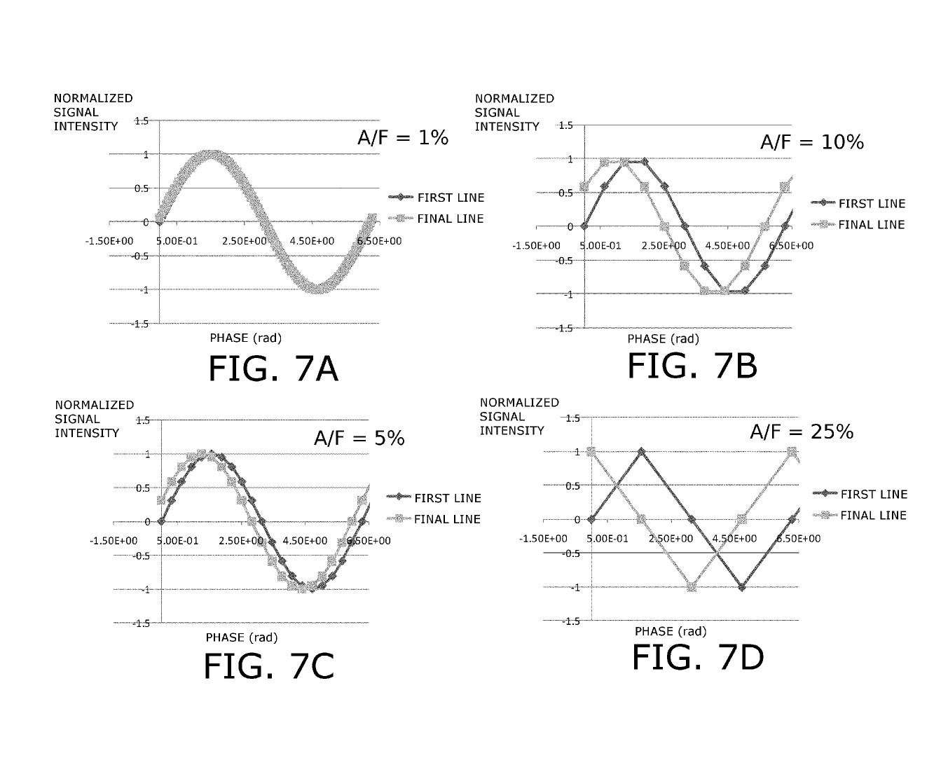

FIG. 7 shows a relative deviation of the received waveform by a line of image sensing elements in one frame, depending on the ratio of the frequency of the acoustic wave to-be-detected (sine wave) and the frame frequency of the CMOS sensor. FIGS. 7A, 7B, 7C and 7D show the simulation results of the received wave forms of the first line and the final line when the ratio of the acoustic wave frequency to the frame frequency (A/F) is 1%, 5%, 10% and 25% respectively. In FIG. 7, the abscissa indicates a phase of the signal (unit: radians), and the ordinate indicates a value normalized by the maximum intensity of the signal.

As shown in FIG. 7, as soon as the received wave form ceases to be continuous when the ratio of the acoustic wave frequency to the frame frequency (A/F) increases, the time-based deviation between the waveform received by the first line and by the final line becomes conspicuous. As a result of the simulation, it was discerned that the time-based deviation of the signals becomes conspicuous in the range of an A/F that is 1% or more and 25% or less, in a state where the continuity required for the received signal is maintained.

If the received waveform having such a time-based deviation is directly used for signal processing, problems occur, such as displaying an image that is deviated from the original position. Therefore according to this embodiment, the signal from the CMOS sensor, which is written to the memory 109, is appropriately corrected by the signal correction unit 111 by using the following methods.

(Signal Correction Method)

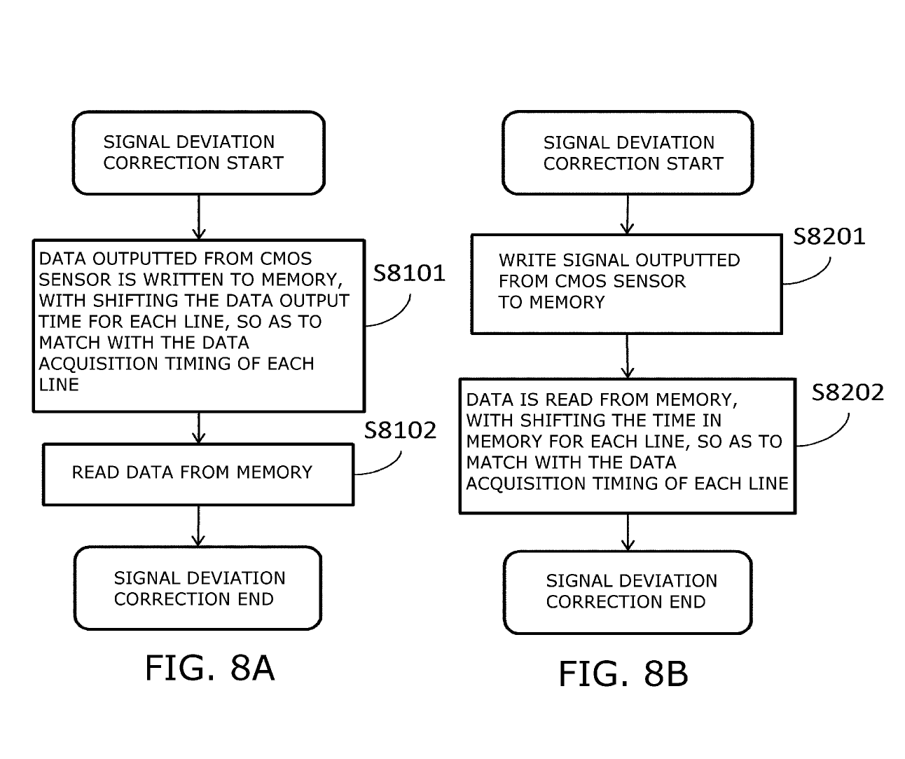

FIG. 8 shows a process of signal deviation correction to solve the above mentioned problem. There are two methods to correct the signal deviation. The first method, as shown in FIG. 8A, is writing the data outputted from the CMOS sensor to the memory 109 with shifting the output time of the data so as to match with the data acquisition timing of each line (step S8101). For processing the signal, this data is read, whereby a signal, of which deviation is corrected, is acquired (Step S8102).

The second method, as shown in FIG. 8B, is writing the data of each line outputted from the CMOS sensor directly to the memory 109 (step S8201). Then the data is corrected when the data is read from the memory. In this case, the time in the memory is shifted when the data is read, so as to match with the data acquisition timing of each line (step S8202).

Concrete methods to shift the time of the data when the data is written or read will be described.

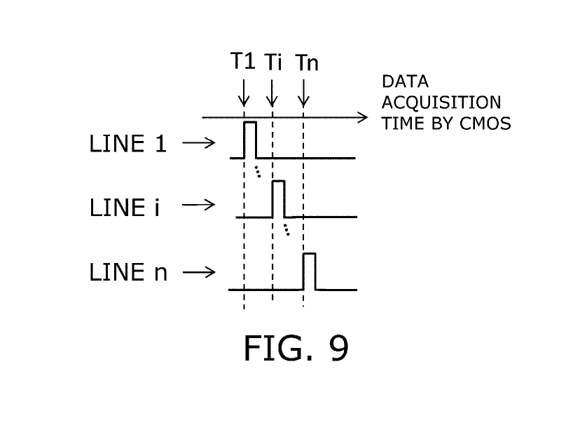

FIG. 9 shows the data acquisition timing of each line by the CMOS sensor. The data acquisition timings of line 1, line i and line n are T1, Ti and Tn respectively.

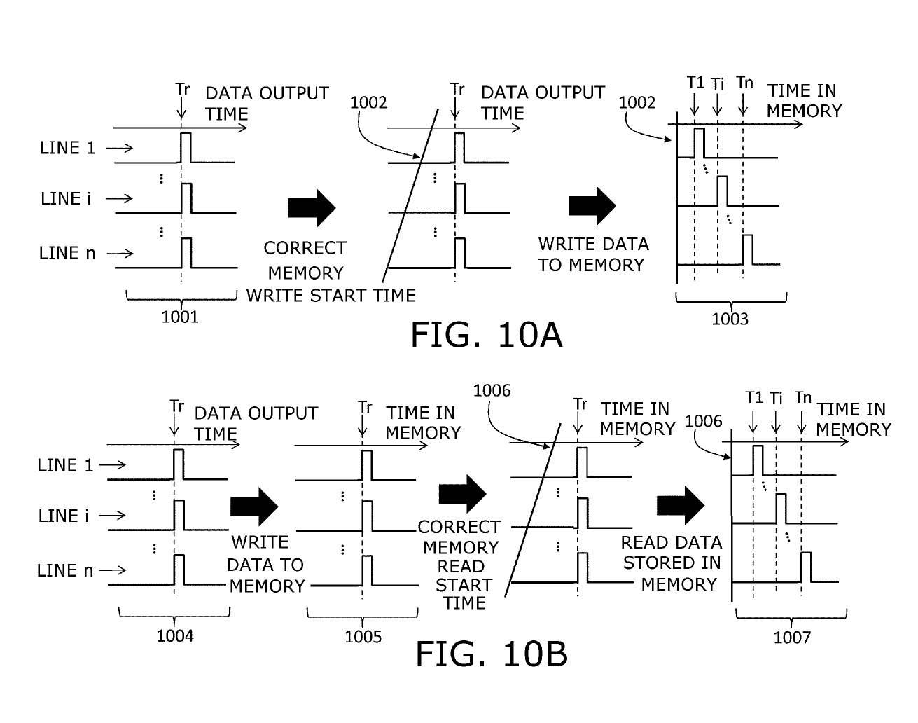

FIG. 10A shows the first method, that is, correcting data when the data is written to the memory 109. First the correction unit receives data of each line outputted at time Tr indicated by the reference numeral 1001. When the data is written to the memory, the write start time to the memory is shifted in each line as indicated by the reference numeral 1002. The write start time 1002 is shifted when the data is written to the memory as indicated by the reference numeral 1003, so that the data acquisition timing of each line reproduces the original timing shown in FIG. 9. Thereby data of each line is written to the memory at the correct data acquisition timing shown in FIG. 9.

FIG. 10B shows the second method, that is correcting data when the data is read from the memory 109. In this case, after the data of each line is received at the output time indicated by the reference numeral 1004, the correction unit writes the output data directly to the memory 109. Therefore, as indicated by the reference numeral 1005, the data acquisition timing of each line in the memory is the same as the reference numeral 1004. Then when the data is read from the memory, the read start time of each line is shifted as indicated by the reference numeral 1006. At this time, the read start time 1006 is shifted so that the data acquisition timing of each line becomes the correct timing shown in FIG. 9, as indicated by the reference numeral 1007. In this way, the data of each line is read from the memory at the correct data acquisition timing shown in FIG. 9.

The output timings from the CMOS sensor of each line are the same as indicated by the reference numerals 1001 and 1004, but the same correction can be performed even if these timings are different from each other.

Instead of shifting the write start timing of the data to the memory as shown in FIG. 10A, the time of the output data of each line indicated by the reference numeral 1001 may be shifted using a signal delay apparatus or the like so as to match with the data acquisition timing shown in FIG. 9, and then the shifted data may be written to the memory. Furthermore, instead of shifting the memory read start time as in FIG. 10B, the timing of each line may be shifted using a signal delay apparatus or the like so as to match with the data acquisition timing shown in FIG. 9, then the shifted data may be read from the memory.

(Data Complementation Method)

As described above, deviation of a signal stored in the memory 109, or deviation of a signal read from the memory 109 is cancelled by the correction unit 111 correcting the deviation based on the data acquisition timing of each line of the CMOS sensor. However, data acquisition of each line is not performed at a same timing. Therefore, in order to acquire the data at the same timing in each line, it is preferable to perform the following data complementation in the correction unit 111 in addition to the signal deviation correction shown in FIG. 8. It does not matter whether the following correction is performed before or after the signal deviation correction process shown in FIG. 8.

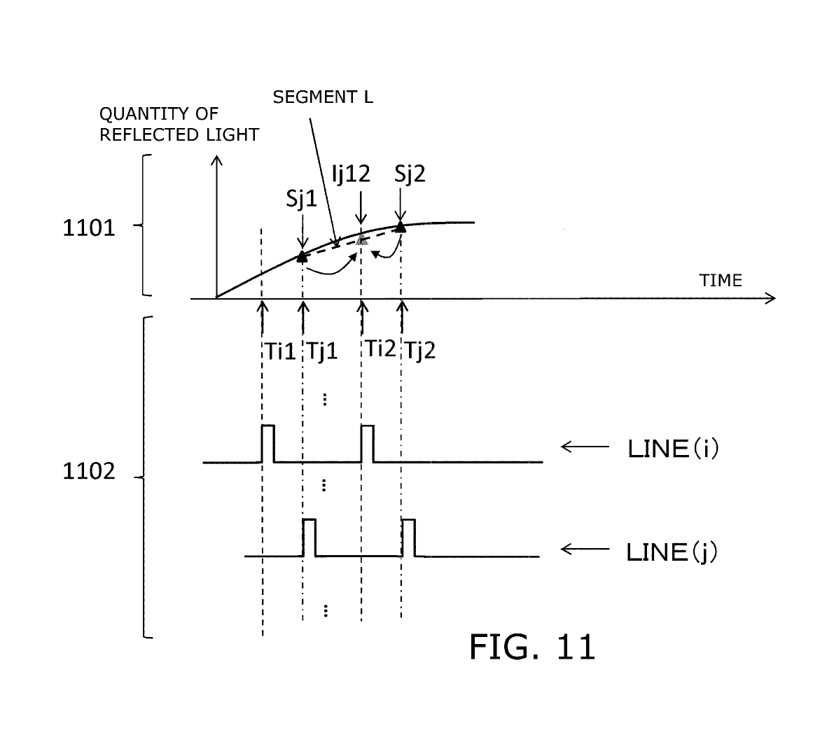

FIG. 11 shows a data complementing method performed at a timing at which data acquisition is not performed. The reference numeral 1101 indicates a graph showing a time-based change of the quantity of reflected light that enters the sensor surface of the CMOS sensor. The abscissa indicates the time, and the ordinate indicates the quantity of reflected light. The reference numeral 1102 indicates a timing chart showing the data acquisition timings of the i-th line and the j-th line (LINE (i) and LINE (j) in FIG. 11). Ti1 and Ti2 denote the data acquisition timings in the i-th line, and Tj1 and Tj2 denote the data acquisition timings of the j-th line. Sj1 and Sj2 denote the quantity of reflected light of the j-th line at timings Tj1 and Tj2 respectively. Here it is assumed that a signal having a same intensity is received at a same timing by an arbitrary image sensing elements. However complementation is possible even when the intensity is distributed on the sensor surface.

In this embodiment, if data is complemented at the timing Ti2 when the j-th line is not acquiring data, the complementation is performed using the data Sj1 and Sj2. In other words, the data Ij12 of the timing Ti2 on the segment L in FIG. 11 is used as the complementation data. The data of each line is complemented by the same method. Thus data at a same timing is acquired by all the lines.

Here it is assumed that the data is complemented by a complementation based on the linear approximation of the adjacent data on both sides, but a complementation using a plurality of data is also possible. An approximation using a curve, instead of a linear approximation, may also be used.

(Composing Elements of Apparatus)

Preferred configuration of the acoustic signal acquiring apparatus and the imaging apparatus according to the embodiment described above will additionally be described.

For the light source for measurement light 107, which emits the measurement light 106, a wavelength-variable laser can be suitably used. It is preferable that the reflectance of the measurement light 106, with respect to the first mirror 301 and the second mirror 302, is 90% or more. The wavelength of the measurement light 106 is preferably an optimum wavelength at which the sensitivity of the Fabry-Perot probe reaches the maximum.

For the excitation light 103 that is irradiated onto the object 101, light with a wavelength that is absorbed by specific components of the components constituting the object 101 is used. A pulsed light is preferable for the excitation light 103. The pulsed light is of a several pico to several hundred nanosecond order, and if the object is an organism, a pulsed light of a several nano to several tens of nanosecond order is even more preferable.

For the excitation light source 104 that generates the excitation light 103, laser is preferable, but a light emitting diode, a flash lamp or the like can also be used. If laser is used, various lasers including a solid-state laser, a gas laser, a dye laser and a semiconductor laser can be used. The difference of the optical characteristic value distribution, depending on the wavelength, can also be measured if dyes and OPOs (optical parametric oscillator(s)) that can convert the oscillation wavelength are used.

For the wavelength of the light source to be used, a 700 nm to 1100 nm region is preferable, where absorption in the organism is minimal. However a wider range than the above mentioned wavelength region, such as a 400 nm to 1600 nm wavelength region, or a terahertz wave, microwave or radio wave region, may be used.

In FIG. 1, the excitation light 103 is irradiated from a direction onto the object such that the shadow of the Fabry-Perot probe 105 does not fall on the object. However if light with a wavelength that transmits through the mirror of the Fabry-Perot probe 105 is used as the excitation light 103, the excitation light 103 may be irradiated from the Fabry-Perot probe 105 side.

In order to detect the photoacoustic wave 102 generated from the object 101 efficiently by the Fabry-Perot probe 105, it is preferable to use an acoustic coupling medium between the object 101 and the Fabry-Perot probe 105. In FIG. 1, water is used as an example of an acoustic coupling medium, and the object 101 is disposed in a water tank 118 filled with water. Another example is coating an acoustic impedance matching gel between the object 101 and the Fabry-Perot probe 105.

Distribution of electric signals in the array type photosensor 108 indicates the intensity distribution of the photoacoustic wave 102 that reaches an area of the Fabry-Perot probe 105 irradiated with the measurement light 106, that is, the pressure distribution of the photoacoustic wave 102. For the reconstruction algorithm to acquire the optical characteristic value distribution (characteristic information) from the acquired distribution of the electric signals, a conventional method, such as universal back projection and phasing addition, can be used. Considering in advance that an area, of which film thickness is abnormal due to the existence of a foreign substance, for example, cannot be used for data acquisition, an image should be generated by correcting the area where data is non-existent when an image reconstruction processing is performed.

The signal processing unit 112 can be any component if the distribution of the time-based change of the electric signal, that indicates an intensity of the photoacoustic wave 102, is stored, and an operation unit can convert this distribution into the optical characteristic value distribution (characteristic information). For example, an information processor, such as a PC, which operates according to a program stored in a storage unit, can be used. It is preferable to include a display unit 113 that displays image information acquired by signal processing.

If lights with a plurality of wavelengths are used as the excitation light 103, the optical coefficient in the organism is calculated for each wavelength, and these values and a wavelength dependency that is unique to the substance (e.g. glucose, collagen, oxyhemoglobin, deoxyhemoglobin) constituting the biological tissue, are compared. Thereby the concentration distribution of the substance constituting the organism can be imaged.

By using the imaging apparatus, the optical characteristic value distribution inside the object can be acquired without generating display image problems due to the deviation of data acquisition timing of the image sensing element group, even if a rolling shutter type photosensor is used as the array type photosensor.

If this imaging apparatus is used in medical fields, the water tank shown in FIG. 1 is not used, instead an acoustic matching agent, such as acoustic impedance matching gel, is applied to the object, that is, an affected area, the Fabry-Perot probe 105 is contacted thereon, and imaging is performed.

### Embodiment 2

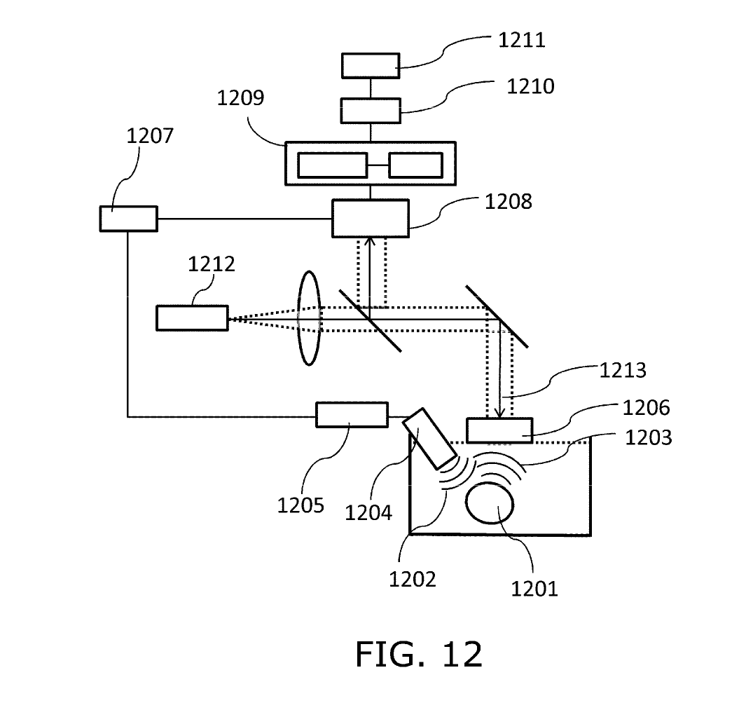

FIG. 12 is a diagram depicting a configuration example of the imaging apparatus of this embodiment. The imaging apparatus of this embodiment images an acoustic impedance distribution in the object. Description on the composing elements the same as Embodiment 1 is omitted.

The imaging apparatus of this embodiment includes a transducer 1204 that generates an elastic wave 1202 and transmits it to an object 1201, and a pulser 1205 that allows the transducer 1204 to generate the elastic wave, instead of the excitation light generation apparatus.

The imaging apparatus also includes a Fabry-Perot probe 1206 that detects an elastic wave, which was reflected on a surface of a tissue having different acoustic impedance, such as a tumor, in the object 1201, and which propagated through the object. Configurations and functions of an array type photosensor 1208 (in this case a CMOS sensor) which uses the rolling shutter method, a light source for measurement light 1212 that irradiates a measurement light 1213, and an optical system that guides the reflected light to the CMOS sensor are the same as Embodiment 1. A control unit 1207 controls an elastic wave generation timing of the pulser 1205, and an imaging timing of the array type photosensor 1208. Thereby an acoustic signal acquiring apparatus is constructed.

The imaging apparatus is constituted by a signal correction unit 1209, a signal processing unit 1210, a display unit 1211, and the acoustic signal acquiring apparatus. The signal correction unit 1209 appropriately corrects an electric signal acquired by the array type photosensor 1208, and transfers the corrected signal to the signal processing unit 1210. The signal processing unit 1210 analyzes the corrected signal and calculates acoustic impedance distribution information (characteristic information). The display unit 1211 displays the calculated acoustic impedance distribution information. A signal correction method by the signal correction unit 1209 is the same as Embodiment 1.

When the elastic wave 1202 is irradiated onto the object 1201, the Fabry-Perot probe 1206 detects an elastic wave 1203, which is reflected by an interface having a different acoustic impedance in the object or the surface of the object, as a reflected light quantity change. A method of detecting the elastic wave 1203 is the same as the method of detecting the photoacoustic wave 102 in Embodiment 1.

For the signal processing to acquire the acoustic impedance distribution from the distribution of the acquired electric signals, phasing addition, for example, can be used. A film thickness abnormality due to a foreign substance or the like can be corrected in the same manner as Embodiment 1. For the signal processing unit 1210, an operation unit the same as Embodiment 1 can be used. Acoustic matching may be performed not by water in a water tank as shown in FIG. 12, but by a matching gel.

If the imaging apparatus of this embodiment is used, an acoustic impedance distribution image inside the object can be acquired without generating a display image problem due to data acquisition timing deviation of the image sensing elements, even if the rolling shutter type photosensor is used as the array type photosensor.

### Embodiment 3

Just like Embodiment 1, an imaging apparatus of this embodiment detects a photoacoustic wave generated from an object by the irradiation of light, and image optical characteristic value distribution information in an organism.

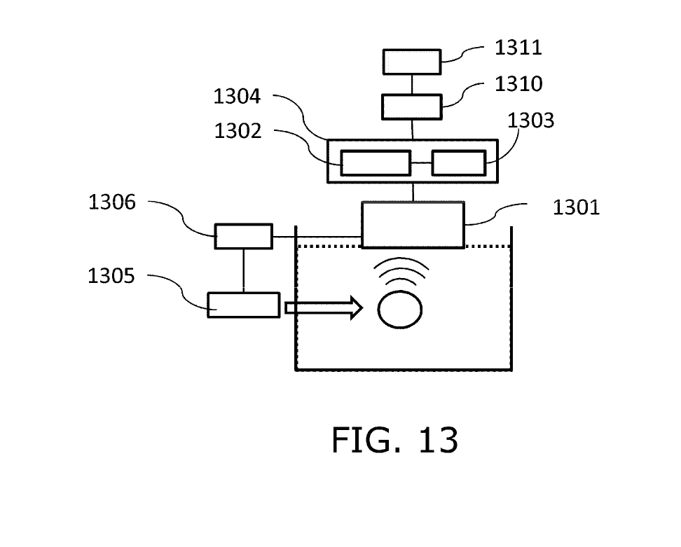

FIG. 13 shows a configuration example of the imaging apparatus of this embodiment. A major difference of this embodiment from Embodiment 1 is that an array type transducer 1301 utilizing piezoelectric phenomena or a change in capacitance is included as means for detecting the photoacoustic wave 102, instead of the Fabry-Perot probe 105 or the array type photosensor 108. This means that this embodiment does not include the light source for measurement light and the optical system to guide the measurement light and the reflected light.

A control unit 1306 of this embodiment controls the signal acquisition and the output of the transducer 1301 and the light emitting timing of an excitation light source 1305. This embodiment also includes a correction unit 1304 that appropriately corrects signals from the array type transducer 1301. The correction unit 1304 is constituted by a memory 1303 and a corrector 1302. The functions of the processing unit 1310 and the display unit 1311 are the same as Embodiment 1. Description on configurations the same as Embodiment 1 is omitted.

For the array type transducer 1301, a probe using such a piezoelectric material as PZT or cMUT (capacitive Micro-machined Ultrasonic Transducer) of a capacitive ultrasonic probe, for example, is used. By the transducer where probes are two-dimensionally arrayed, the sound pressure distribution on the two-dimensional surface is detected and outputted as electric signals. The array type transducer 1301 of this embodiment does not output signals from all the probes simultaneously, but sequentially outputs received signals from each probe group with a certain time difference. In this case, receiving element refers to each probe in the array, and receiving element group refers to a horizontal line of the array.

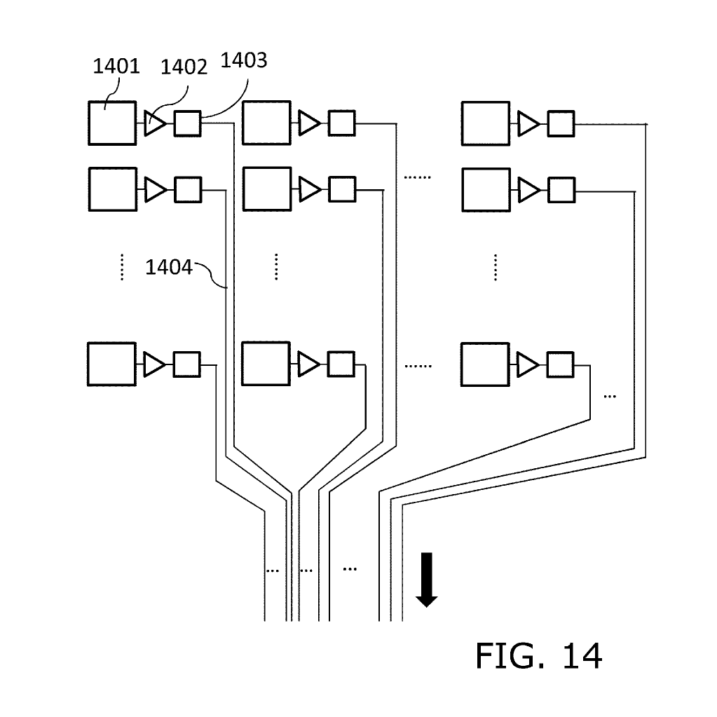

As a comparison example, FIG. 14 shows a configuration of the array type transducer in the case of outputting the received signals from all the probes simultaneously. The transducer includes probes 1401 (receiving elements), amplifiers 1402 that amplify the received signals, and A/D converters 1403 that convert the received signals from analog into digital. The received signal from each probe is outputted to the outside via a signal line 1404 which transfers only one signal from one probe. In this case, one amplifier and one A/D converter are required for each probe, and if sound pressure distribution on a two-dimensional surface is acquired in a wide area or at high density, a required number of probes increases and cost increases.

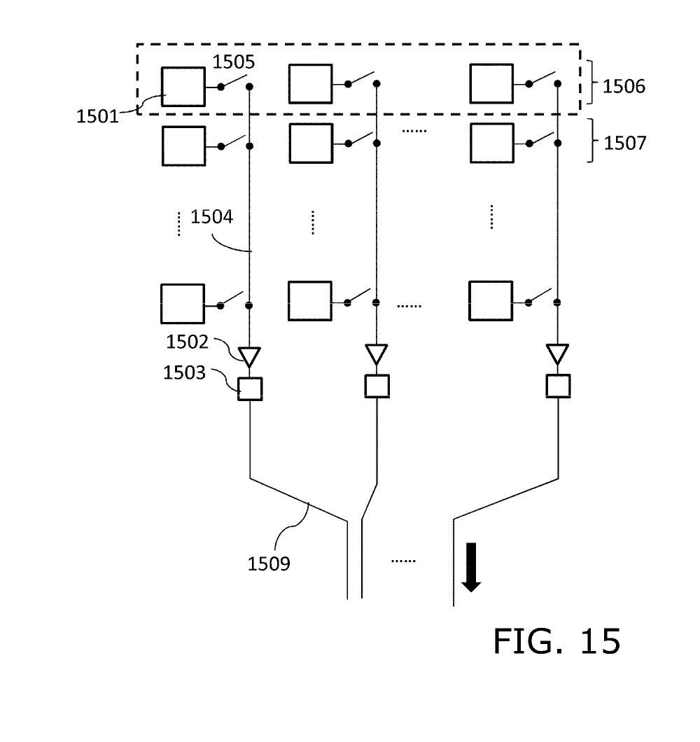

Therefore in this embodiment, the array type transducer shown in FIG. 15 is used. The transducer includes the probes 1501 and signal lines 1504, where one amplifier 1502 and one A/D converter 1503 are disposed for each signal line 1504. Each signal line 1504 includes a switch 1505 that switches a line to read a signal. A signal in each vertical line is outputted to the outside via a signal line 1509.

The array type transducer in FIG. 15 outputs signals while sequentially switching the switches on each horizontal line. In other words, only the switches on the horizontal line 1506 are turned ON first, and the signals of the probe group on the line 1506 are outputted to the outside. Then only the switches on the horizontal line 1507 are turned ON, and the signals on this line are outputted. By sequentially repeating this operation, the received signals of the two-dimensionally array probes are outputted to the outside. In this configuration, only one amplifier and one A/D converter are disposed on each vertical line, hence cost can be reduced compared with the configuration in FIG. 14. For example, in the case of disposing N×N number of probes, N² number of amplifiers and A/D converters are required in FIG. 14, but only N number of amplifiers and A/D converters are required in this embodiment.

In this embodiment however, the received signals of the transducer 1301 are outputted by the rolling shutter method, as in the case of using the rolling shutter type photosensors in Embodiments 1 and 2, which means that the same problem as Embodiment 1 is generated. In other words, signals are sequentially read from each horizontal line, therefore if write timing to the memory 1303 is not appropriately corrected, the signals that are deviated on each line are processed, and as a result a correct image cannot be outputted, as described in Embodiments 1 and 2. Description of the method of correcting the signals from each horizontal line by the corrector 1302, which is the same as Embodiment 1, is omitted here.

In the above description, the switches are switched to simultaneously read the acoustic signals of the probe group on each horizontal line, but another method may be used if the same kind of reading is possible. It is not always necessary to simultaneously read the signals of the probe group on each horizontal line, but the signals of an arbitrary probe group may be read simultaneously, and the sequence of reading the signals may also be arbitrary. Furthermore, it is not always necessary to output signals from all the two-dimensionally arrayed probe groups, but signals on every other line may be outputted to make data acquisition faster.

By using the imaging apparatus described in this embodiment, the optical characteristic value distribution inside the object can be acquired without generating display image problems due to the deviation of the signal acquisition timing, even if the array type transducer that sequentially acquires signals from each probe group is used.

As mentioned in the previous embodiments, acoustic matching may be performed by a matching gel or the like, instead of water in a water tank as shown in FIG. 13.

### Embodiment 4

Just like Embodiment 2, an imaging apparatus of this embodiment images an acoustic impedance distribution inside an object by detecting a reflected wave of an elastic wave emitted from a transducer to the object.

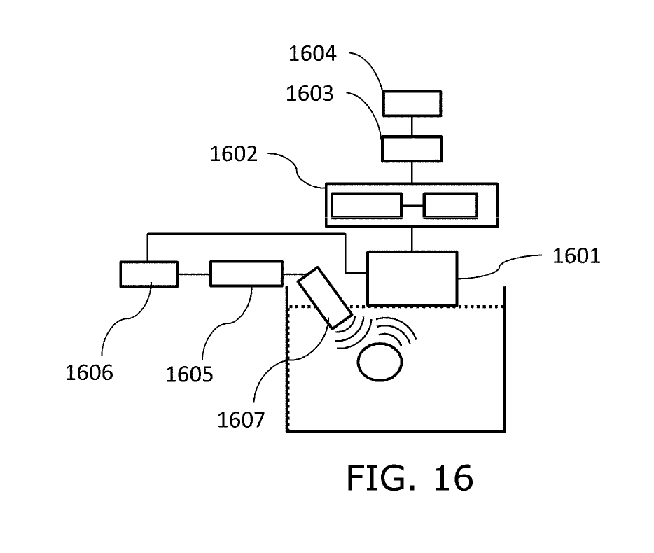

FIG. 16 shows a configuration example of the imaging apparatus of this embodiment. A major difference of this embodiment from Embodiment 2 is that an array type transducer 1601, utilizing piezoelectric phenomena or a change in capacitance, is included as means for detecting the elastic wave 903, instead of the Fabry-Perot probe 906 or the array type photosensor 908. This means that this embodiment does not include the light source 912 and the optical system to guide the measurement light 913 to the Fabry-Perot probe 906, and to guide the reflected light thereof to the array type photosensor 908, which are used in Embodiment 2.

Description on an array type transducer 1601, a signal correction unit 1602, a signal processing unit 1603 and a signal display unit 1604, which are the same as Embodiment 3, is omitted. This embodiment includes a control unit 1606 that controls signal acquisition and output of the transducer 1601 and signal generation timing of a pulser 1605. A transmission wave is generated from a transducer 1607 according to the signal from the pulser.

By using the imaging apparatus described in this embodiment, the acoustic impedance distribution inside the object can be acquired without generating display image problems due to the deviation of the signal acquisition timing, even if the array type transducer that sequentially acquires signals from each probe group is used.

As mentioned in the previous embodiments, acoustic matching may be performed by a matching gel or the like, instead of water in a water tank as shown in FIG. 16.

As described in each embodiment, according to the present invention, problems generated when using an array type transducer, particularly the Fabry-Perot probe utilizing the CMOS sensor based on the rolling shutter method, can be prevented. As a result, if the object is an organism, optical characteristic value distribution inside the organism and the concentration distribution of a substance constituting the biological tissue acquired from this information can be imaged. Therefore the present invention can be used as a medical image diagnostic apparatus for diagnosing tumors and vascular diseases, and observing the prognosis of chemotherapy.

Those skilled in the art can easily apply the present invention to non-destructive inspections or the like targeting xenobiotic objects. In other words, the present invention can be used as an inspection apparatus in a wide range of applications.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-127528, filed on Jun. 18, 2013, which is hereby incorporated by reference herein in its entirety.

1. An object information acquiring apparatus, comprising:
a receiver in which a plurality of receiving elements to receive acoustic signals based on an acoustic wave propagated from an object are disposed on a two-dimensional surface, the plurality of receiving elements being divided into a plurality of receiving element groups each including at least one receiving element respectively;
a corrector configured to correct signals received by the receiver; and
a processor configured to acquire characteristic information about at least a region in the object using the signals corrected by the corrector, wherein
the receiver receives the acoustic signals for each of the plurality of receiving element groups with a time difference, and acquires the received signals, and
the corrector corrects a time-based deviation among the received signals acquired for each receiving element group, based on the timing at which each receiving element group has received the acoustic signals.

2. The object information acquiring apparatus according to claim 1, wherein
the plurality of receiving element groups included in the receiver constitutes a frame in a predetermined sequence, and performs frame imaging in which the acoustic signals are received repeatedly in frame units, and
the receiver acquires a received waveform for each receiving element group based on the acoustic signal received by each of the receiving element groups in each frame.

3. The object information acquiring apparatus according to claim 2, wherein the corrector receives the acoustic signals received by the plurality of receiving element groups, and further includes a memory to which the received acoustic signal is written for each frame.

4. The object information acquiring apparatus according to claim 3, wherein based on the timing at which each of the plurality of receiving element groups has received the acoustic signal, the corrector performs the correction when writing the received acoustic signal to the memory.

5. The object information acquiring apparatus according to claim 3, wherein
the corrector writes the acoustic signals received from the plurality of receiving element groups, directly to the memory, and then
when reading the acoustic signals from the memory and transferring the acoustic signals to the processor, the corrector performs the correction based on the timing at which each of the plurality of receiving element groups has received the acoustic signal.

6. The object information acquiring apparatus according to claim 1, wherein the corrector complements an intensity of a signal at a timing at which the receiving element group does not receive the acoustic signals, based on the intensities of the acoustic signals received by the receiving element group.

7. The object information acquiring apparatus according to claim 1, wherein the plurality of receiving elements included in the receiver are disposed in arrays in horizontal and vertical directions on the two-dimensional surface, and the receiving element group is formed for each horizontal line of the array.

8. The object information acquiring apparatus according to claim 1, wherein
the receiver includes a Fabry-Perot interferometer, and
the plurality of receiving elements are image sensing elements of an array type photosensor that detects measurement light that enters the Fabry-Perot interferometer and is then reflected.

9. The object information acquiring apparatus according to claim 8, wherein the array type photosensor is a CMOS sensor.

10. The object information acquiring apparatus according claim 1, wherein the plurality of receiving elements are elements that detect an acoustic wave using piezoelectric material, or elements that detect an acoustic wave using a change in capacitance.

11. The object information acquiring apparatus according claim 1, wherein the acoustic wave propagated from the object is a photoacoustic wave generated from the object irradiated with excitation light.

12. The object information acquiring apparatus according to claim 1, wherein the acoustic wave propagated from the object is an acoustic wave which is transmitted to the object and then reflected.

13. The object information acquiring apparatus according to claim 1, further comprising a display configured to display the characteristic information acquired by the processor.

14. An acoustic signal acquiring apparatus, comprising:
a receiver in which a plurality of receiving elements to receive acoustic signals are disposed on a two-dimensional surface, the plurality of receiving elements being divided into a plurality of receiving element groups including at least one receiving element respectively;
a corrector configured to correct signals received by the receiver; and
a processor configured to analyze the signals corrected by the corrector, wherein
the receiver receives the acoustic signals for each of the plurality of receiving element groups with a time difference, and acquires the received signals, and
the corrector corrects a time-based deviation among the received signals acquired for each receiving element group, based on the timing at which each receiving element group has received the acoustic signals.

15. A control method of an object information acquiring apparatus, which has a receiver in which a plurality of receiving elements are disposed on a two-dimensional surface, the plurality of receiving elements being divided into a plurality of receiving element groups each including at least one receiving element respectively, a corrector and a processor, the control method comprising:
a step of the receiver receiving acoustic signals based on an acoustic wave propagated from an object for each of the plurality of receiving element groups with a time difference, and acquiring the received signals;
a step of the corrector correcting a time-based deviation among the received signals acquired for each receiving element group, based on the timing at which each receiving element group has received the acoustic signals; and
a step of the processor acquiring characteristic information in the object using the signals corrected by the corrector.

16. (canceled)
